(19) United States
(12) Patent Application Publication
(10) Pub. No.: US 2025/0355426 A1
(43) Pub. Date: Nov. 20, 2025

(54) MATERIAL PROPERTIES PREDICTION DEVICE FOR ROLLED PRODUCTS

(71) Applicant: TMEIC Corporation, Tokyo (JP)

(72) Inventor: Mirei KIHARA, Tokyo (JP)

(73) Assignee: TMEIC Corporation, Tokyo (JP)

(21) Appl. No.: 18/854,553

(22) PCT Filed: Mar. 14, 2023
(86) PCT No.: PCT/JP2023/009919

§ 371 Date: Oct. 7, 2024

(51) Int. Cl. G05B 19/418

(52) U.S. Cl. CPC G05B 19/41875; G05B 2219/32193

(57) ABSTRACT

A material properties prediction device for rolled products includes: an approximate model creation unit that creates an approximate model offline that comprehensively predicts material properties of a group of rolled products to be manufactured on a rolling line; and a material properties prediction unit that online predicts material properties in individual three-dimensional mesh-shaped areas of a rolled product manufactured on the rolling line, by using the approximate model. The approximate model creation unit includes: a dataset creation unit that creates a dataset to be used to create approximate model, in which the dataset creation unit has a condition setting unit that sets rolling conditions for the group of rolled products, and a material calculation unit that calculates metallurgical phenomena and material properties under the rolling conditions; and a model parameter determination unit that determines parameters expressing the approximate model by using the dataset.

### TECHNICAL FIELD

The present disclosure relates to a material properties prediction device for rolled products, and more particularly, to a device for predicting material properties of rolled products manufactured in a hot rolling process.

### BACKGROUND ART

The material properties of rolled products (hereinafter also referred to as “products”) made of metal materials such as steel vary depending on their alloy composition, and the heating conditions, processing conditions, and cooling conditions of the hot rolling process. The material properties include, for example, mechanical properties (strength, formability, toughness, etc.) and electromagnetic properties (magnetic permeability, etc.). The alloy composition is adjusted by controlling the amounts of component elements added. In this component adjustment, one lot unit is large in which a component adjustment furnace is used that can hold about 100 tons of molten steel, for example. Therefore, it is impossible to change the amount added for each individual rolled product that weighs about 15 tons. Therefore, in order to manufacture a hot-rolled product coil with desired material properties, it is important to appropriately control heating conditions, processing conditions, and cooling conditions.

In the hot rolling process, different rolled products are created by changing the target values of various process parameters, which are process conditions related to product quality and operating conditions. For example, process parameters include: the target temperature at each point on the rolling line such as the entry-side temperature and the delivery-side temperature of the finishing mill, and the coiling temperature; schedules related to the rolling reduction of thickness and width of bar or strip, such as the transfer bar thickness at the delivery side of the roughing mill and the rolling reduction rate of each pass; necessity of use of the descaler, which is provided in the finishing mill and roughing mill, for each pass; necessity of use of, and initial flow rate of an interstand cooling disposed between the stands of the roughing mill and finishing mill; the amount of lubricating oil used in finishing mill; and the cooling pattern used in the run-out table.

Conventionally, process parameters related to heating, processing, and cooling have had target values for heating temperatures, target values for dimensions after processing, target values for cooling rates, and the like, each of which is set for a specification of the rolled product. To achieve these target values, methods of controlling temperatures and dimensions have commonly been employed. Note that while the product dimension target values are specified in advance, the bar or strip thickness target values, temperature target values, and cooling rate target values at the delivery side of each stand are determined based on many years of experience. However, requirements for product specifications recently have become significantly more sophisticated and diversified, and it may not always be possible to appropriately determine these target values through methods based on experience.

Patent Literature 1 listed below discloses a device that simulates manufacturing steps offline using a process model that models individual manufacturing steps of heating, processing, and cooling, in order to examine in advance whether a product manufactured under a certain alloy composition and process parameters obtains a desired product quality.

Additionally, there is a growing need to make the control of material properties even more stringent than the control that has been conventionally carried out within the scope of warranty. Conventionally, as stipulated in JIS (Japanese Industrial Standards), the condition (tolerance range) has been that the material properties exceed standard values. For example, a tensile test has been performed using a sample taken from a product to determine whether the measured value exceeds a standard value. However, higher accuracy has recently been required even in steps after product shipment. The conventional tolerance range as described above may not be sufficient, for example, in the forming steps (drawing, bending, pressing, etc.) that are downstream steps. There have been cases in which the material-to-be-rolled is too hard to form, cases in which the spring back amount (elastic recovery amount) after pressing is too large and of poor shape fixability, cases in which edges crack in forming, and the like. For this reason, problems have arisen in which the above-mentioned target values cannot necessarily be controlled appropriately with the setting methods and material properties control methods based on experience.

A conventional method of controlling steps of a rolling process includes: controlling the temperature of the entire rolling coil using the output value of a pyrometer disposed on the rolling line; and further controlling the material properties that are closely related to the rolling temperature. Specifically, in the rolling line, pyrometers are disposed on the delivery side of the heating furnace, the entry and delivery sides of the roughing mill, the entry and delivery sides of the finishing mill, the entry side of the coiler, and the like. The pyrometer measures the temperature at the central part of the material-to-be-rolled in the bar or strip width direction (hereinafter also simply referred to as “width direction”). Control is then performed so that the output value from the pyrometer matches the target temperature, from the host computer, determined based on experience. As described above, conventionally, in controlling the steps of the rolling process, the material properties in the width direction of the material-to-be-rolled have not been taken into consideration.

The end parts (edges) in the width direction of the material-to-be-rolled are easily cooled, and a temperature difference occurs between edges and the central part. There is a case in which a rolling line includes a device for increasing the temperature of the end parts in the width direction of the material-to-be-rolled or a device for preventing decrease in the temperature of the end parts in the width direction of the material-to-be-rolled. For example, during cooling after rolling, edge masks are used to prevent cooling water from splashing onto the edge parts. Alternatively, before finishing rolling, the edge parts are heated to increase the temperature with an induction heating device such as an edge heater.

Furthermore, there has recently been cases in which scan pyrometers are installed at the front and the rear of the devices described above in order to verify the effects of the devices described above. Use of a scan pyrometer allows measuring the temperature distribution in the width direction of the material-to-be-rolled. Additionally, scan pyrometers are also employed in multi gauges that have recently been employed in rolling lines, to use the temperature distribution in the width direction of the material-to-be-rolled to correct measured values. Multi gauges are composite measuring instruments, each of which alone measures a bar or strip thickness, a crown, a bar or strip width, etc. and its measurement accuracy recently has improved significantly.

As described above, equipment for measuring the temperature distribution in the width direction of the material-to-be-rolled is being introduced into rolling lines. Additionally, some attempts have been made to calculate the temperature distribution in the width direction of the material-to-be-rolled and utilize it for control. Patent Literature 2 listed below discloses means for calculating the temperature distribution in the thickness direction and width direction of a material-to-be-rolled. Further, Patent Literature 3 listed below discloses a method of equalizing the temperature in the width direction by controlling an edge heater based on calculation of the temperature distribution in the width direction.

For material properties as well as strip thickness, strip width, shape, and the like, if an unachieved part is made, the unachieved part is commonly required to be cut off in the dividing line in the downstream step by comparing with actual data and adding the allowance (margin amount). Although the amount to be cut off at this time is directly related to the yield, conventionally, when the amount to be cut off is determined, the amount to be cut off has been only roughly determined. In view of this situation, it has been desired to optimize the amount of material to be cut off, and to reduce the unachieved part in material properties as much as possible through process improvements, from the viewpoint of improving yield even when the unachieved part in material properties is made.

For this reason, properties control has conventionally been attempted by inputting manufacturing conditions such as heating, processing, and cooling in the rolling steps and predicting the properties of the rolled product using a properties prediction model.

Patent Literature 4 listed below discloses a method in which a model obtained by mathematization of metallurgical phenomena is used that predicts changes in the microstructure of materials-to-be-rolled and mechanical properties of final products, and the model performs model learning using actual mechanical properties values obtained from mechanical properties measurement test results such as tensile tests and structure observations conducted on part of product coils. Patent Literature 5 listed below discloses a method of outputting material properties distribution in which positions in two-dimensional directions of the longitudinal direction and the width direction are associated with material properties values. Patent Literature 6 listed below discloses a method of storing operating conditions and actual material properties, searching for similar operating conditions, and estimating material properties at all positions of a product coil online in a mesh form. Furthermore, Patent Literature 7 listed below discloses a method of predicting material properties using a neural network.

### CITATION LIST

### Patent Literature

[PTL 1] JP 6292309

[PTL 2] JP 6197676

[PTL 3] JP 6447710

[PTL 4] JP 5396889

[PTL 5] JP 2022-48037 A

[PTL 6] JP 6086155

[PTL 7] JP 2005-315703 A

### SUMMARY OF THE INVENTION

### Problems to be Solved by the Invention

However, in the material properties prediction based on a model obtained by mathematization of metallurgical phenomena as shown in Patent Literature 4 and Patent Literature 5, the computational load increases as the model, which has modeled microscopic phenomena with high fidelity, increases accuracy. For example, even if the number of calculation points in a product coil is several, the calculation time may take several seconds. For example, if what is desired is prediction performed on a 1 km product coil with a mesh size of 2 m pitch in the rolling direction, 3 points in the strip thickness direction, and 5 points in the strip width direction, the calculation points will be 7500 points. In this case, if the amount of calculation per calculation point is 1 second, the calculation time will be more than 2 hours. Rolling operation is often continuously rolling equivalent or similar product categories. If desires for reflecting the results of a material in the next material or in operational changes of the materials in the same lot, it takes too much time for cases in which each coil may be rolled at intervals of about 2 to 5 minutes.

Furthermore, in Patent Literatures 6 and 7, relationships between past operating conditions and actual material properties are explored and modeled, and the material properties of a newly rolled product coil is predicted based on empirical rules. Such empirical rule models are generally known to be high speed and contribute to solving the problem of computational load. However, models based on past operating conditions and actual material properties have limited approximation accuracy when modeling complicated material behavior, and cannot be expected to have sufficient predictive accuracy.

The present disclosure has been made to solve the above-mentioned problems. An object of the present disclosure is to provide a material properties prediction device for rolled products capable of predicting material properties of an entire group of rolled products online at high speed and with high accuracy.

### Solution to Problem

A first aspect of the present disclosure relates to a material properties prediction device for rolled products, the material properties prediction device predicting material properties of a rolled product manufactured on a rolling line. The material properties prediction device comprises: an approximate model creation unit that offline creates an approximate model that comprehensively predicts material properties of a group of rolled products to be manufactured on the rolling line; and a material properties prediction unit that online predicts material properties in individual three-dimensional mesh-shaped areas of a rolled product manufactured on the rolling line, by using the approximate model created by the approximate model creation unit. The approximate model creation unit includes: a dataset creation unit has a condition setting unit that sets rolling conditions for the group of rolled products, and a material calculation unit that calculates metallurgical phenomena and material properties under the rolling conditions, the dataset creation unit creating a dataset to be used to create the approximate model; and a model parameter determination unit that determines parameters expressing the approximate model using the dataset.

A second aspect further includes the following characteristics in addition to the first aspect. The dataset creation unit creates the dataset in which the rolling conditions set by the condition setting unit are used as explanatory variables and the material properties calculated by the material calculation unit are used as objective variables.

A third aspect further includes the following characteristics in addition to the first aspect. The material properties prediction unit includes: a rolling data collection unit that online collects rolling data obtained in manufacturing rolled products on the rolling line; a model input creation unit that online creates input data to the approximate model, from the rolling data collected by the rolling data collection unit; an approximate model calculation unit that online calculates material properties of individual three-dimensional mesh-shaped areas of a product coil by inputting the input data created by the model input creation unit into the approximate model; and a material properties output unit that outputs material properties of the individual areas calculated by the approximate model calculation unit, information expressing positions of the individual areas in the rolled product, and information related to the material properties.

A fourth aspect further includes the following characteristics in addition to the first aspect. The approximate model is a machine learning model.

A fifth aspect further includes the following characteristics in addition to any one of the first to fourth aspects. The material properties prediction unit includes a material properties correction unit that corrects material properties using material properties results, the material properties being calculated by the approximate model calculation unit using the approximate model, the material properties results being calculated using a metallurgical phenomenon model obtained by mathematization of metallurgical phenomena.

### Advantageous Effects of the Invention

According to the present disclosure, a dataset is also created in advance that corresponds to rolling conditions (temperature conditions, processing conditions, time/speed conditions) that have not been implemented in the actual rolling process or rolling conditions that have little experience, and an approximate model is created offline using the created dataset, thereby making it possible to create an approximate model that is applicable to the entire group of rolled products and has high approximation accuracy. Use of the approximate model created in this way allows reducing the computational load for online prediction of the material properties in individual three-dimensional mesh-shaped areas of the rolled product. Moreover, since it is possible to calculate the material properties of all areas (parts) of a rolled product with a high speed, the results of the rolled product can be reflected in the next rolled product or in operational changes for rolled products in the same lot.

### BRIEF DESCRIPTION OF DRAWINGS

FIG. 1 is a diagram showing an example of a hot strip rolling line to which a material properties prediction device for rolled products according to Embodiment 1 is applied.

FIG. 2 is a block diagram showing a rolling system according to Embodiment 1.

FIG. 3 is a block diagram showing functions of the material properties prediction device for rolled products according to Embodiment 1.

FIG. 4 is a diagram showing an example of the hardware configuration of the material properties prediction device for rolled products.

FIG. 5 is a block diagram showing a configuration of an approximate model creation unit.

FIG. 6 is a diagram for explaining datasets created by a dataset creation unit.

FIG. 7 is a schematic diagram for explaining an example of cooling pattern of explanatory variables.

FIG. 8 is a diagram for explaining a configuration of the dataset creation unit and creation of the dataset.

FIG. 9 is a diagram for explaining the setting of a material calculation unit and the explanatory variables by a condition setting unit.

FIG. 10 is a diagram for explaining metallurgical phenomenon calculation and setting of objective variables by the material calculation unit.

FIG. 11 is a schematic diagram showing an example of an approximate model.

FIG. 12 is a block diagram showing a configuration of a material properties prediction unit.

FIG. 13 is a schematic diagram of an example showing a mesh area for which the approximate model calculation unit calculates material properties.

FIG. 14 is a schematic diagram showing an example of output of a material properties output unit.

FIG. 15 is a schematic diagram showing a configuration of a material properties correction unit in Embodiment 2.

FIG. 16 is a schematic diagram showing a correction method in the material properties correction unit in Embodiment 2.

### DESCRIPTION OF EMBODIMENTS

Hereinafter, embodiments of the present invention will be described in detail with reference to the drawings, using an example of a case of predicting material properties of rolled products being manufactured on a hot rolling line. Note that common elements in each figure are denoted by the same reference numerals and characters and duplicate explanation will be omitted.

### Embodiment 1

### Rolling Line

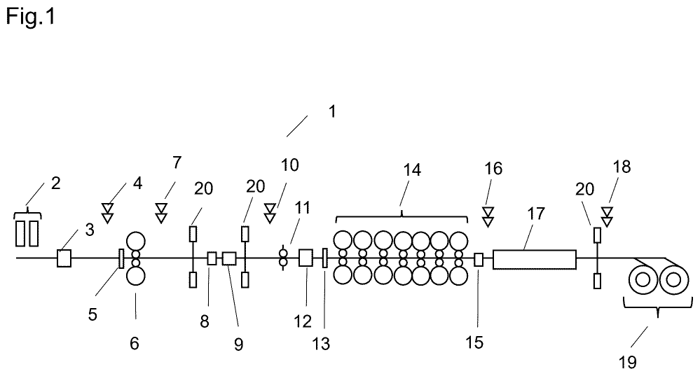

FIG. 1 is a diagram showing an example of a hot strip rolling line (hereinafter also referred to as “rolling line”) to which a material properties prediction device for rolled products (hereinafter also referred to as “prediction device”) according to Embodiment 1 is applied. In the present embodiment, a prediction device for predicting the material properties of a rolled product manufactured on the rolling line shown in FIG. 1 will be described, but the prediction device of the present disclosure is also applicable to other rolling lines.

The rolling line includes a heating device, rolling mills, a cooling device, a down coiler, and a conveying table connecting these. These devices are driven by actuators such as electric motors and hydraulic devices. Specifically, the rolling line 1 shown in FIG. 1 includes, in order from the upstream side of the conveying table, a heating furnace 2, a high-pressure descaling device 3, a roughing mill entry-side pyrometer 4, a roughing edger 5, a roughing horizontal rolling mill (hereinafter also referred to as “roughing mill”) 6, a roughing mill delivery-side pyrometer 7, an edge heater 8, a bar heater 9, a finishing mill entry-side pyrometer 10, a crop shear 11, a finishing mill entry-side descaling device 12, an F1 edger 13, a finishing mill 14, a multi gauge 15, a finishing mill delivery-side pyrometer 16, a run-out table 17, a coiler entry-side pyrometer 18, and a down coiler 19.

The heating furnace 2 is a furnace for heating the material-to-be-rolled (slab), and is controlled so as to obtain a desired slab temperature increase pattern and heating furnace extraction temperature. In the following description, the material-to-be-rolled includes not only slabs and strip, but also materials in the middle of being completed as product coils. The high-pressure descaling device 3 injects high-pressure water to the material-to-be-rolled from above and below after the material leaves the heating furnace 2 and thereby removes scale from the surface of the material. The roughing mill entry-side pyrometer 4 is disposed on the entry side (upstream side) of the roughing mill 6, and measures a roughing mill entry-side temperature that is a temperature of a surface (for example, the upper surface) of the central part in the width direction of the material-to-be-rolled. The roughing edger 5 rolls the material-to-be-rolled in the slab width direction. The roughing mill 6 performs roughing rolling of the slab in the slab thickness direction. In the roughing mill 6, the material-to-be-rolled is rolled in a plurality of passes to obtain a desired thickness. Therefore, a reversible rolling mill can be used as the roughing mill 6. The roughing mill delivery-side pyrometer 7 measures the temperature of a surface (for example, the upper surface) of the material-to-be-rolled. The roughing mill delivery-side pyrometer 5 is disposed on the delivery side (downstream side) of the roughing mill 6. When the material-to-be-rolled has passed through the roughing mill 6, the roughing mill delivery-side pyrometer 7 measures the surface temperature at the central part in the width direction as the roughing mill delivery-side temperature.

The edge heater 8 is a device that increases the temperature of the end parts (edges) in the width direction of the material-to-be-rolled by electromagnetic induction heating or the like in order to control the temperature of the material-to-be-rolled. The bar heater 9 is a device that increases the temperature of the entire material-to-be-rolled by electromagnetic induction heating or the like in order to control the temperature of the material-to-be-rolled. The finishing mill entry-side pyrometer 10 is disposed on the entry side of the finishing mill 14, and measures a finishing mill entry-side temperature that is a temperature of the surface (for example, the upper surface) of the central part in the width direction of the material-to-be-rolled. The crop shear 11 cuts the head end part and tail end part of the bar. The finishing mill entry-side descaling device 12 removes scale from the surface of the bar on the entry side of the finishing mill 14. The F1 edger 13 is disposed on the entry side of the finishing mill 14, and has its rollers to be into contact with the material-to-be-rolled from the lateral sides. The F1 edger 13 deforms the material-to-be-rolled so that the material-to-be-rolled has a narrower width but does not buckle. The finishing mill 14 consists of a single or a plurality of stands, and in the example shown in FIG. 1, it is a tandem finishing mill consisting of seven stands. The finishing mill 14 performs finish rolling on the material-to-be-rolled to a predetermined strip thickness.

The multi gauge 15 is a composite measuring instrument which alone can perform various kinds of measurement. The multi gauge 15 has, for example, a configuration in which a plurality of X-ray detectors are arranged in the width direction of the material-to-be-rolled. The multi gauge 15 measures, for example, the strip thickness distribution of the material-to-be-rolled in the width direction. Preparing one multi gauge 15 allows measuring the strip thickness, crown, and strip width of the material-to-be-rolled. The measurement accuracy of multi gauges 15 has recently been improved. For this reason, it is cheaper to purchase one multi gauge 15 than to individually purchase a strip thickness gauge, a crown gauge, and a strip width gauge, and multi gauges 15 have been increasingly introduced into hot rolling lines. The multi gauge 15 includes a pyrometer and a scan pyrometer inside. The multi gauge 15 measures the temperature of the material-to-be-rolled, and uses the measured value to correct the detected value of the X-ray detector.

The finishing mill delivery-side pyrometer 16 measures a temperature of a surface (for example, the upper surface) of the material-to-be-rolled. The finishing mill delivery-side pyrometer 16 is disposed on the delivery side (downstream side) of the finishing mill 14. The finishing mill delivery-side pyrometer 16 measures the surface temperature of the central part in the width direction of the material-to-be-rolled that has passed through the finishing mill 14 as the finishing mill delivery-side temperature. The finishing mill delivery-side pyrometer 12 is disposed on the delivery side of the finishing mill 10. The finishing mill delivery-side temperature of the material-to-be-rolled closely relates to the formation of the metallographic structure and material properties (tensile strength, yield stress, elongation, etc.) of the product. Therefore, the finishing mill delivery-side temperature of the material-to-be-rolled needs to be properly controlled.

The run-out table 17 is a cooling device that cools the material-to-be-rolled with cooling water in order to control the temperature of the rolled product. In order to control the temperature of the material-to-be-rolled, the run-out table 17 supplies cooling water from nozzles to the surfaces of the material-to-be-rolled, for example. The run-out table 17 includes a large number of nozzles in the longitudinal direction of the material-to-be-rolled (the conveying direction of the conveying table). These nozzles are divided into a plurality of banks. Control of the nozzles is performed for each bank, and the cooling rate of the material-to-be-rolled is controlled. Water cooling is performed in banks that are supplied with cooling water, and air cooling is performed in banks that are not supplied with cooling water. Note that the rolling line may further include a cooling table, a forced cooling device, or the like, as a cooling device.

The coiler entry-side pyrometer 18 is disposed on the entry side (upstream side) of the down coiler 19. After the material-to-be-rolled passes through the run-out table 17, the coiler entry-side pyrometer 18 measures the surface temperature at the central part in the width direction as the coiling temperature. The finishing mill delivery-side pyrometer 12 is disposed on the delivery side of the finishing mill 10. The coiling temperature of the material-to-be-rolled closely relates to the formation of the metallographic structure and material properties (tensile strength, yield stress, elongation, etc.) of the product. Therefore, the coiling temperature of the material-to-be-rolled needs to be properly controlled.

The down coiler 19 is a device for coiling a rolled product into a shape that is easy to convey. The conveying table is a device for conveying the rolled product in each step to the next step. These devices are driven by actuators such as electric motors and hydraulic devices.

The rolling line 1 shown in FIG. 1 further includes scan pyrometers 20. The scan pyrometers 20 measure the temperatures of the surface (for example, the upper surface, or the upper surface and the lower surface) of the material-to-be-rolled, at least at a plurality of positions in the width direction of the material-to-be-rolled. The scan pyrometers 20 are preferably disposed at the front and rear of the device for improving the temperature of the material-to-be-rolled. The example shown in FIG. 1 shows a case in which the scan pyrometers 20 are installed at the front of the edge heater 8, the rear of the bar heater 9, and the front and rear of the run-out table 17. Note that the scan pyrometer 20 disposed on the entry side of the run-out table 17 is provided inside the multi gauge 15.

### Rolling System

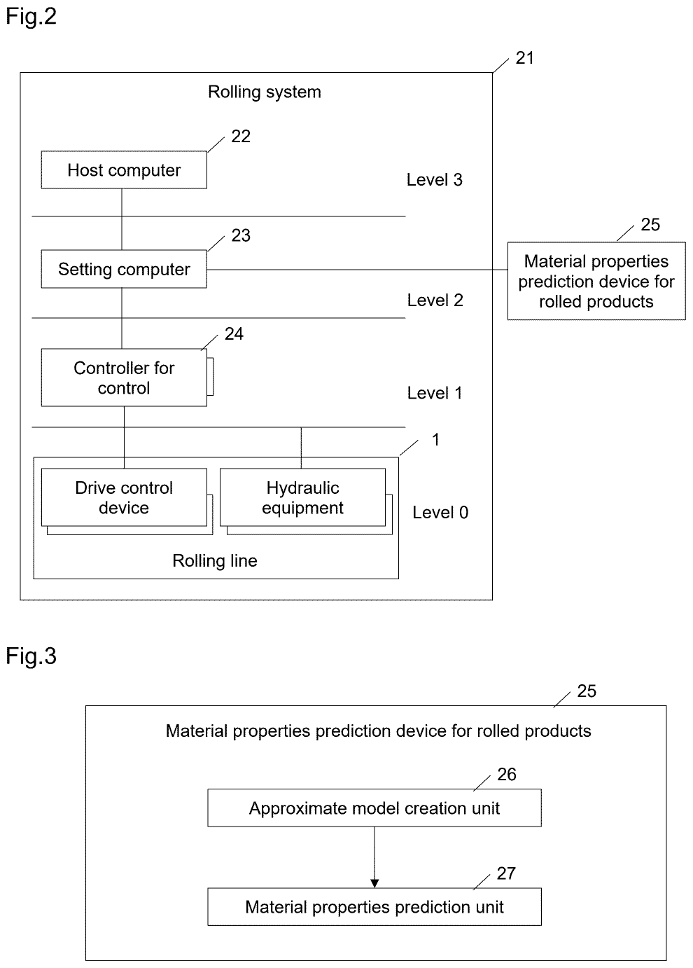

FIG. 2 is a block diagram showing a rolling system 21 according to Embodiment 1. The rolling system 21 is a control system for the rolling line 1 and has a hierarchical structure from levels 0 to 3. The level 0 includes a drive control device that controls electric motors each driving a device on the rolling line 1 and hydraulic equipment (hydraulic devices) each driving a device on the rolling line 1. The level 1 has a controller for control 24. The level 2 has a setting computer 23. The level 3 has a host computer 22 for production control. A material properties prediction device for rolled products 25, which will be described later, is connected to the setting computer 23 and can receive rolling data.

The hot rolling process changes the process conditions related to product quality and operating conditions, that is, the target values of various process parameters, and thereby creates different products. Process control is performed by the setting computer 23 so as to achieve the target product quality, that is, to achieve the target values of the various process parameters described above.

A target value of the process parameter may be specified by the host computer 22 on the level 3 that is located above the setting computer 23 on the level 2. In addition, the target value of the process parameter may be specified using a table in the database of the setting computer 23 with keys such as the steel type, bar or strip thickness, and bar or strip width. Also, the target value of process parameter may be changed during rolling by manual intervention of an operator.

The setting computer 23 has model expressions expressing physical phenomena of each process such as heating, rolling, cooling, and conveying in the rolling line 1. The setting computer 23 performs setting calculations using model expressions expressing physical phenomena of the process so as to achieve the target values (process conditions) of the various process parameters described above in actual operation. The setting calculation repeats calculation of control target values for various actuators and calculation of states of the material-to-be-rolled (predicted state values of the metal material) at each step of the process.

The control target values of the actuator include the roll gaps of the rolling mills 6 and 14, rolling speeds, conveying speeds, flow rates of the descaler and various sprays, and ON/OFF of the valves of the run-out table. The state of the material-to-be-rolled (predicted state value of the metal material) at each step of the process includes dimensions, shapes, temperatures, and microstructures.

The controller for control 24 receives the setting calculation results from the setting computer 23 and controls various actuators so as to follow the control target values. In the hot rolling process in actual operation, various sensors are installed throughout the rolling line 1 to monitor and collect actual values of parameters that affect process control, such as temperatures, shapes, bar or strip thicknesses, bar or strip widths, and rolling loads.

These actual values are used for improving accuracy and controlling quality of process control and model expressions. The setting computer 23 compares each target value of the process parameter with: the actual value obtained by various sensors; and the actual calculated value that the setting computer 23 has recalculated from the actual value and the calculated value. If the target value of the process parameter is unachieved, the setting computer 23 performs setting calculation again. Based on the results, various controls such as feedforward control, feedback control, and dynamic control are performed.

Even if a model expression of a process accurately simulates a physical phenomenon, model prediction errors occur in reality. Therefore, engineers fine-tune the coefficients and constants for each term in the model expression to improve the predictive accuracy of the model expression. Items to be adjusted are coefficients and constants for each term in the model expression. The coefficients and constants are managed in a database belonging to the setting computer 23 for each hierarchy using tables for each hierarchy classified by factors that tend to cause model errors, such as steel type, target bar or strip thickness, target bar or strip width, and target temperature. The items to be adjusted is mainly adjusted in rolling a new steel type or rolling with a new process parameter combination as well as starting up operation. The items to be adjusted may be adjusted by an engineer based on experience or numerical analysis results, or nowadays the items may be adjusted semi-automatically using statistical methods such as neural networks. The learning terms are terms multiplied and added to the model expressions in order to fill in the errors between the model outputs and the outputs of the actual process.

### Material Properties Prediction Device for Rolled Products

FIG. 3 is a block diagram showing functions of the material properties prediction device for rolled products 25 according to Embodiment 1. The prediction device 25 predicts the mechanical properties of a product coil rolled in the rolling line 1 shown in FIG. 1. The prediction device 25 includes an approximate model creation unit 26 and a material properties prediction unit 27.

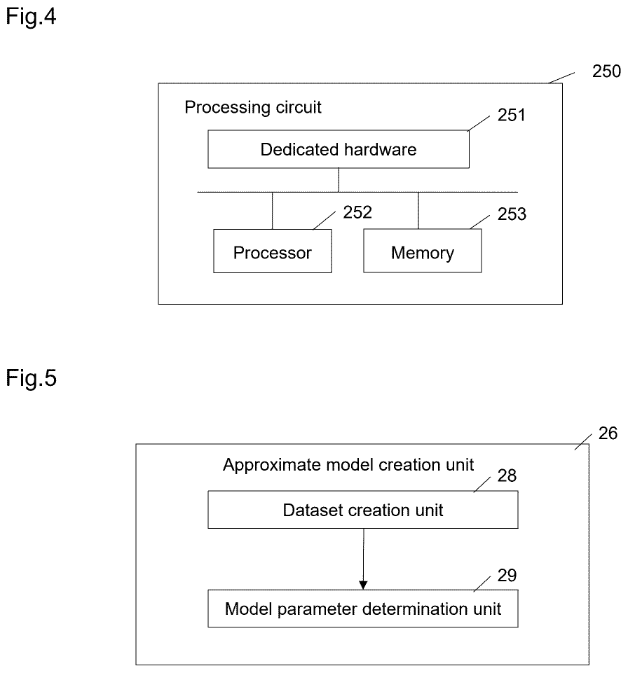

FIG. 4 is a diagram showing an example of the hardware configuration of the prediction device 25. Each function of the prediction device 25, which will be described later, can be realized by a processing circuit 250 shown in FIG. 4. This processing circuit 250 may be dedicated hardware 251. This processing circuit may include a processor 252 and a memory 253. This processing circuit may be partially formed as dedicated hardware 251 and further include a processor 252 and a memory 253. In the example of FIG. 4, the processing circuit 250 is partially formed as dedicated hardware 251, and the processing circuit 250 also includes a processor 252 and a memory 253.

The processing circuit 250 may be at least one piece of dedicated hardware 251. In this case, processing circuit 250 is, for example, a single circuit, a composite circuit, a programmed processor, a parallel programmed processor, an ASIC, an FPGA, or a combination thereof.

The processing circuit 250 may include at least one processor 252 and at least one memory 253. In this case, each function of the prediction device 25 is realized by software, firmware, or a combination of software and firmware. Software and firmware are written as programs and stored in memory 253. The processor 2252 reads and executes the programs stored in the memory 253, and thereby realizes the functions of the approximate model creation unit 26 and the material properties prediction unit 27. The processor 252 is also called a CPU (Central Processing Unit), a central processing unit, a processing unit, an arithmetic unit, a microprocessor, microcomputer, or a DSP. The memory 253 is, for example, a nonvolatile or volatile semiconductor memory such as a RAM, a ROM, a flash memory, an EPROM, an EEPROM, or the like. In this way, the processing circuit 250 can implement each function of the prediction device 25 using hardware, software, firmware, or a combination thereof.

The approximate model creation unit 26 creates an approximate model 39 that comprehensively and rapidly predicts the mechanical properties of a group of hot rolled products manufactured on the rolling line 1, that is, rolled products (product coils) of all steel types, dimensions, and operating conditions that can be manufactured on rolling line 1. The word “comprehensively” means a manner of covering not only the mechanical properties of rolled products that have been produced on rolling line 1, but also the mechanical properties of rolled products that may be manufactured on rolling line 1 in the future. The details of the approximate model creation unit 26 will be described below.

FIG. 5 is a block diagram showing a configuration of the approximate model creation unit 26. The approximate model creation unit 26 includes a dataset creation unit 28 and a model parameter determination unit 29. The dataset creation unit 28 creates a dataset to be used for creating the approximate model 39. The model parameter determination unit 29 uses the dataset created by the dataset creation unit 28, to determine parameters expressing the approximate model 39 through an optimization method or the like.

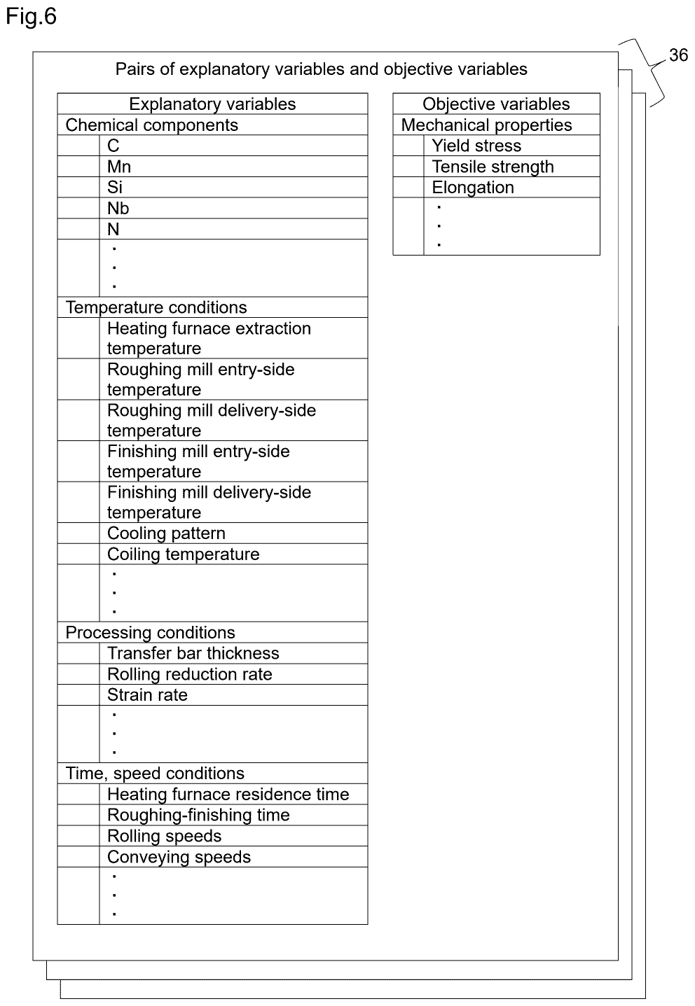

FIG. 6 is a diagram for explaining the dataset created by the dataset creation unit 28. The data set 36 created by the dataset creation unit 28 is an aggregate of data in which data of explanatory variables 37 and data of objective variables 38 forms a pair. Each pair configured with data of explanatory variables 37 corresponding to part of a certain operating condition, and data of objective variables 38 corresponding to the mechanical properties of the coil manufactured by the rolling line 1 under the operating condition. Although there are various operating conditions, the explanatory variables 37 to be selected are operating conditions, which are particularly correlated with mechanical properties (hereinafter referred to as “first operating conditions”), such as chemical components, temperature conditions, processing conditions, time conditions, or speed conditions. The content of chemical components in steel is adjusted to create different steel types. Chemical components contributing to mechanical properties, such as C, Mn, Si, Nb, N, and Ti, are included in the explanatory variables 37. Temperature conditions, like chemical components, are adjusted to create different steel types, and greatly contribute to mechanical properties. A temperature history of a certain part of the product coil is time-series data, but when it is given as the explanatory variable 37, one-dimensional data is given that is obtained by instantaneously cutting the time series data at important points. For example, one-dimensional data is such as heating furnace extraction temperature=1200° C., roughing mill entry-side temperature=1100° C., roughing mill delivery-side temperature=1000°° C., finishing mill entry-side temperature=950° C., finishing mill delivery-side temperature=900° C., and coiling temperature=650° C. Then, the one-dimensional data is given to each explanatory variable 37 to express the main temperature history that affects the mechanical properties. The explanatory variables 37 to be selected are the temperatures that can be measured with a pyrometer or a scan pyrometer in online product rolling and the temperatures recalculated with actual temperatures by the setting computer 23, which are temperature conditions that affect mechanical properties. The explanatory variables 37 also includes temperature conditions in which variations may occur from product to product, such as the heating furnace extraction temperature and the roughing rolling entry side. The explanatory variables 37 also includes: temperature conditions that differ in the rolling direction and the width direction, such as finishing rolling delivery-side temperature and coiling temperature; and temperature conditions in which a temperature drop occurs at the width end, such as roughing mill entry-side temperature and roughing mill delivery-side temperature. Furthermore, the cooling conditions in the run-out table 17 adjusts the temperature path, and thereby creates the mechanical properties. Specifically, in addition to the target temperatures of the finishing mill delivery-side temperature and the coiling temperature, part of the cooling pattern conditions are set and controlled that includes the position of the water cooling portion, the water cooling speed, the water cooling time, and the air cooling time (normal cooling). Furthermore, there may be a case in which: the run-out table 17 is divided into the first half and the second half; an intermediate pyrometer is installed at the midpoint of the two; and in addition to the above target temperature, the cooling pattern conditions are set and controlled for the target temperature of the intermediate pyrometer and for each of the first half and the second half of the run-out table 17 (step cooling). Therefore, cooling pattern conditions, which will be described later, are also added to the explanatory variables. The processing conditions are operating conditions such as the rolling reduction rate and strain rate of each stand. It is known that rolling reduction rate and strain rate affect the microstructure and, as a result, the final mechanical properties. Therefore, the rolling reductions and the strain rates are added to the explanatory variables as processing conditions for each stand. Alternatively, a certain rolling reduction and a certain strain rate may be added to the explanatory variables as integrated information such as the average of the entire finishing rolling or the average of the stand in the second half of the finishing rolling. The time conditions include a heating furnace residence time that is a slab residence time in the heating furnace and a roughing-finishing time that is a time from completion of roughing rolling to start of finishing rolling, each of which varies from product to product, and affects mechanical properties. Therefore, adding the time conditions to the explanatory variables may improve the prediction performance of the variation in mechanical properties from product to product. Furthermore, speed conditions such as rolling speeds and conveying speeds at each position change from the head end to the tail end in the rolling direction, and affect mechanical properties. Therefore, including the speed conditions in the explanatory variables may improve the prediction performance of the variation in mechanical properties in the product. Mechanical properties to become objective variables include yield stress, tensile strength, and elongation. The dataset 36 comprehensively includes: operating conditions for coils of all steel types and dimensions, manufactured on the rolling line 1, at any position including the head end and the tail end in the longitudinal direction and end parts in the width direction; and mechanical properties when the coils are rolled under these operating conditions.

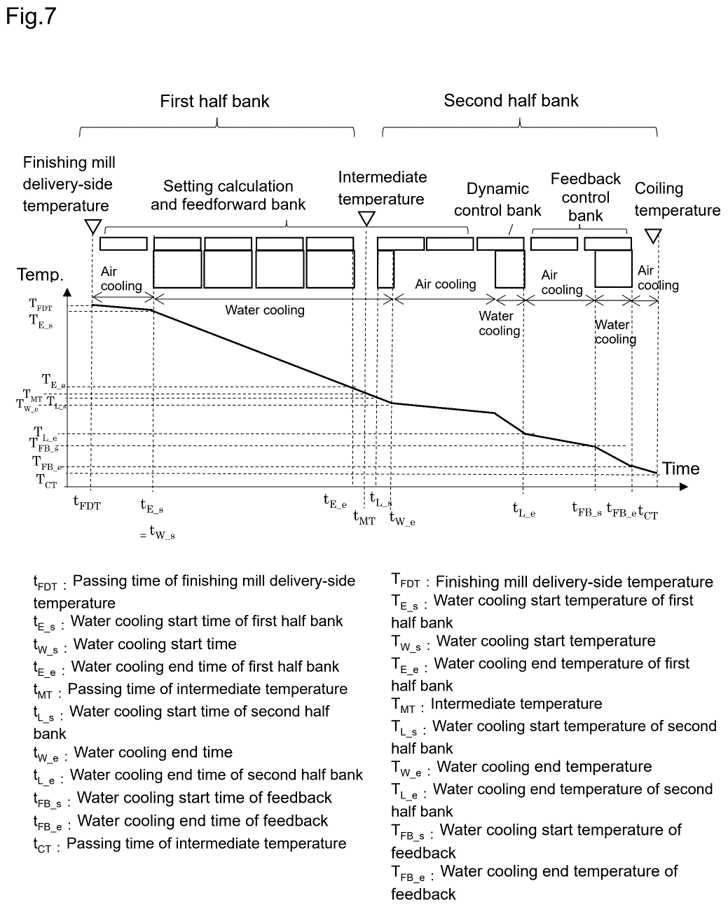

FIG. 7 is a schematic diagram for explaining an example of the cooling pattern of the explanatory variables 37. FIG. 7 shows an example of a cooling pattern for normal cooling. In the example shown in FIG. 7, the upstream side banks of the run-out table 17 are used for an initial cooling setting by a setting calculation and feedforward control using an actual finishing mill temperature value. Furthermore, the two most downstream side banks are used for feedback control using an actual coiling temperature, and the bank upstream of the bank used for feedback control is used for dynamic control to follow conveying speed change. In order to express the cooling pattern shown in FIG. 7 with explanatory variables, for example, the explanatory variables are a cooling rate of the water cooling portion, a cooling rate of the water cooling portion in the first half, a cooling rate of the water cooling portion in the second half, the average cooling rate in the first half, the average cooling rate in the second half, and the cooling rate of the water cooling portion in the feedback banks. For example, the cooling rate of the water cooling portion V_{cool} is calculated with the following expression (1) for the temperature drop due to water cooling in the banks excluding the dynamic control bank and the feedback control banks.

$$\begin{matrix}[ Math . 1 ] & \\ {V}_{cool} = \frac{{T}_{W \_ s} - {T}_{W \_ e}}{{t}_{W \_ s} - {t}_{W \_ e}} & ( 1 )\end{matrix}$$

Here, t_{W_s} is a water cooling start time excluding the dynamic control bank and the feedback control banks, tw e is a water cooling end time excluding the dynamic control bank and the feedback control banks, T_{W_s} is a temperature at the start of water cooling, and T_{W_e} is a temperature at the end of water cooling.

It is known that the mechanical properties are affected differently between when cooling is performed in the first half of the run-out table 17 and when cooling is performed in the second half thereof. The cooling rate of the water cooling portion in the first half, the cooling rate of the water cooling portion in the second half, the average cooling rate in the first half, the average cooling rate in the second half, and the like are calculated and used as explanatory variables. For example, the cooling rate V_{E_cool} of the water cooling portion in the first half is calculated with the following expression (2) for the temperature drop due to water cooling in the banks between the finishing mill delivery-side temperature and the intermediate temperature.

$$\begin{matrix}[ Math . 2 ] & \\ {V}_{E \_ cool} = \frac{{T}_{E \_ s} - {T}_{E \_ e}}{{t}_{E \_ s} - {t}_{E \_ e}} & ( 2 )\end{matrix}$$

Here, t_{E_s} is the water cooling start time of the first half banks, t_{E_e} is the water cooling end time of the first half banks, T_{E_s} is the water cooling start temperature of the first half banks, and T_{E_e} is the water cooling end temperature of the first half banks.

The cooling rate of the water cooling portion in the second half is also calculated with the time and temperature information in the second half, and is included in the explanatory variables. For example, the average cooling rate V_{E_ave} in the first half is calculated with the following expression (3) for the temperature drop due to water cooling and air cooling in the banks between the finishing mill delivery-side temperature and the intermediate temperature.

$$\begin{matrix}[ Math . 3 ] & \\ {V}_{E \_ ave} = \frac{{T}_{FDT} - {T}_{MT}}{{t}_{FDT} - {t}_{MT}} & ( 3 )\end{matrix}$$

Here, t_{FDT} is the passing time of the finishing mill delivery-side temperature, t_{MT} is the passing time of the intermediate temperature, T_{FDT} is the finishing mill delivery-side temperature, and T_{MT} is the intermediate temperature.

The average cooling rate in the second half is also calculated with the time and temperature information in the second half, and included in the explanatory variables. Depending on the feedback control for controlling the coiling temperature, the cooling pattern by the feedback banks differs in the rolling direction of the materials-to-be-rolled, and the result may affect the mechanical properties. In order to take such disturbance into consideration, the cooling rate of the water cooling portion of the feedback banks is added to the explanatory variables. The cooling rate V_{FB_cool} of the water cooling portion of the feedback banks is calculated with the following expression (4) for the water cooling portion of the feedback banks.

$$\begin{matrix}[ Math . 4 ] & \\ {V}_{FB \_ cool} = \frac{{T}_{FB \_ s} - {T}_{FB \_ e}}{{t}_{FB \_ s} - {t}_{FB \_ e}} & ( 4 )\end{matrix}$$

Here, t_{FB_s} is the water cooling start time of the feedback banks, t_{FB_e} is the water cooling end time of the feedback banks, T_{FB_s} is the water cooling start temperature of the feedback banks, and T_{FB_e} is the water cooling start temperature of the feedback banks.

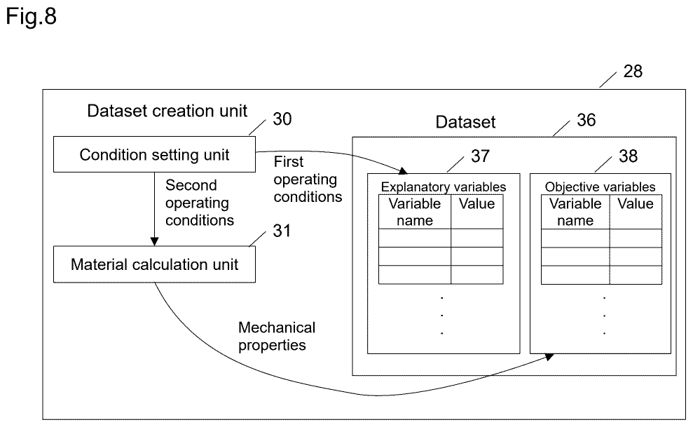

FIG. 8 is a diagram for explaining a configuration of the dataset creation unit 28 and creation of a dataset. The dataset creation unit 28 includes a condition setting unit 30 and a material calculation unit 31. The condition setting unit 30 sets first operating conditions related to the explanatory variables 37 of the dataset 36. Furthermore, the condition setting unit 30 sets operating conditions, in the material calculation unit 31, such as chemical components, processing histories and temperature histories, necessary for metallographic structure calculation with the metallurgical phenomenon model in the metallographic structure calculation unit 44. Hereinafter, the operating conditions related to the input of the metallurgical phenomenon model used by the metallographic structure calculation unit 44 will be referred to as “second operating conditions”. The first operating conditions and the second operating conditions include the same data, but also include different data. For example, the metallurgical phenomenon model predicts changes in microstructure from time to time. Therefore, the second operating conditions include data that is spatially and temporally continuous at each equipment position and at each time, such as processing histories and temperature histories. The material calculation unit 31 calculates metallurgical phenomena and mechanical properties based on the set second operating conditions. Further, the material calculation unit 31 sets data of the objective variables 38 of the dataset 36.

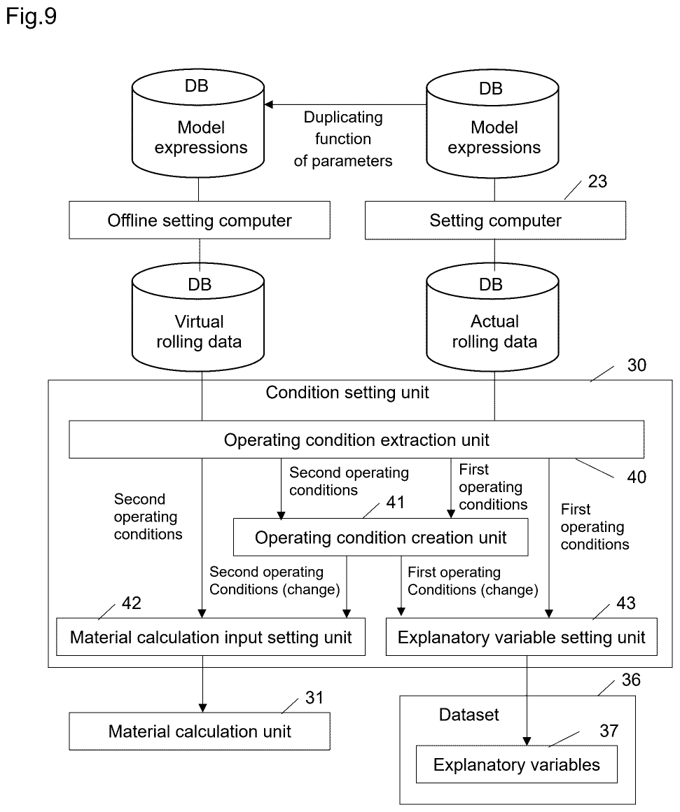

FIG. 9 is a diagram for explaining the setting of the material calculation unit 31 and the explanatory variables 37 by the condition setting unit 30. The condition setting unit 30 includes, for example, an operating condition extraction unit 40, an operating condition creation unit 41, a material calculation input setting unit 42, an explanatory variable setting unit 43.

For example, the operating condition extraction unit 40 extracts: the first operating conditions, which are related to the explanatory variables 37 mentioned above, such as chemical components, processing histories, and temperature histories; and the second operating conditions to be used by the material calculation unit 31, from the virtual rolling data of a virtual coil virtually rolled by the offline setting computer.

The above-mentioned offline setting computer is, for example, a device as disclosed in Patent Literature 1, synchronizes process parameters with the online setting computer, and thereby can simulate the actual operation. This allows a variety of operating conditions to be created through offline setting calculation without putting any load on the actual operation. For example, this allows simulating operation that satisfy various machine constraints even for products and rolling conditions without manufacturing experience in actual operation.

The operating conditions and explanatory variables 37 to be used in the material calculation unit 31 may include operating conditions and explanatory variables 37 extracted from the actual rolling data of product coils that are actually rolled. Alternatively, operating conditions such as processing histories like strain, and temperature histories of each part in the product may be created using analysis data, which is more detailed than setting calculations, such as results of finite element analysis.

The operating conditions to which the approximate model 39 can be applied should include disturbances that are not measured or calculated in actual operation. Disturbances include, for example, variation in a chemical component, temperature unevenness in reheating in a heating furnace, temperature drop in the material-to-be-rolled due to unexpected oscillation before finishing rolling, and failure to maintain a cooling rate due to poor functioning of sprays. The disturbances is created in a simulated manner with the offline setting computer mentioned above. Alternatively, the disturbances may be directly added to the processing histories or temperature histories of the actual rolling data or virtual rolling data.

The operating condition creation unit 41 intentionally adds changes that simulate disturbances, to part of the rolling data created by duplicating the actual rolling data and virtual rolling data.

The material calculation input setting unit 42 passes operating conditions to the material calculation unit 31. The operating conditions are any of: operating conditions extracted by the operating condition extraction unit 40; operating conditions obtained by adding changes corresponding to disturbances by the operating condition creation unit 41 to the operating conditions extracted by the operating condition extraction unit 40; or operating conditions created by the operating condition creation unit 41 from external data such as finite element analysis results without using the operating condition extraction unit 40.

The explanatory variable setting unit 43 extracts data corresponding to the explanatory variables 37 from any of: operating conditions extracted by the operating condition extraction unit 40; operating conditions obtained by adding changes corresponding to disturbances by the operating condition creation unit 41 to the operating conditions extracted by the operating condition extraction unit 40; or operating conditions created by the operating condition creation unit 41 without using the operating condition extraction unit 40. The explanatory variable setting unit 43 adds the extracted data to the dataset 36 as the explanatory variables 37.

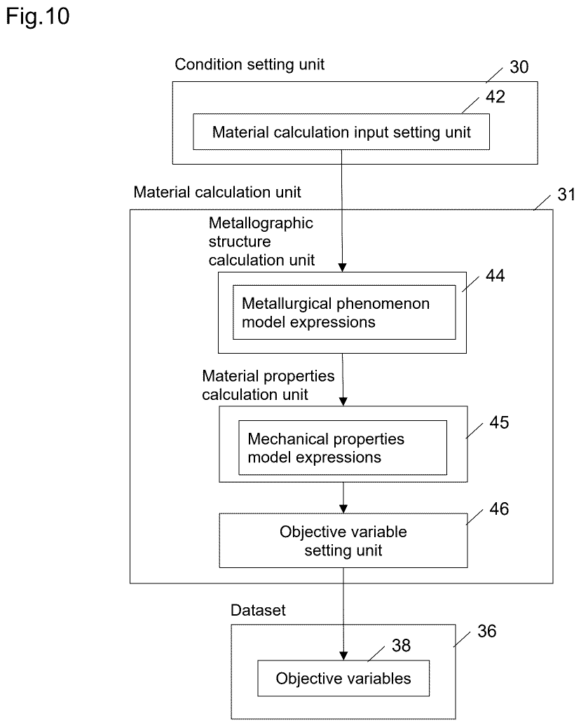

FIG. 10 is a diagram for explaining the metallurgical phenomenon calculation and the setting of the objective variables 38 by the material calculation unit 31. The material calculation unit 31 includes a metallographic structure calculation unit 44, a material properties calculation unit 45, and an objective variable setting unit 46.

The metallographic structure calculation unit 44 uses rolling data such as chemical components, processing histories, and temperature histories set in the material calculation input setting unit 42 of the condition setting unit 11, to calculate the metallographic structure with a metallurgical phenomenon model obtained by mathematization of metallurgical phenomena. The properties of the metallographic structure to be calculated include the volume fraction of ferrite, pearlite, bainite and martensite, and the grain size of ferrite and austenite. Various metallurgical phenomenon models have been proposed and includes a group of mathematical expressions expressing static recovery, static recrystallization, dynamic recovery, dynamic recrystallization, grain growth, and transformation. An example of this model is published in Sosei-Kakou Series 7 Ita-Atsuen (Plastic Processing Technology Series 7 Plate Rolling) (Corona Publishing), pages 198-229. Use of this model allows calculation of the volume fraction of ferrite, pearlite, bainite, martensite, etc., austenite grain size, and ferrite grain size. Handling of micro-order structure changes requires subdividing the calculation steps and calculation areas, resulting in a large calculation load. The dataset 36 must contain a huge number of pairs of explanatory variables and objective variables of several thousand to tens of thousands of coils. Since the metallographic structure calculation unit 44 performs calculations under a variety of operating conditions ranging from thousands to tens of thousands of cases, the calculations are performed in an offline environment that does not affect online calculations in actual operation.

The material properties calculation unit 45 calculates mechanical properties based on the chemical components included in the rolling data mentioned above and metallographic structure calculated values obtained from the metallographic structure calculation unit 44. The mechanical properties to be measured include yield stress, tensile strength, and elongation. Note that in many cases, the metallurgical phenomenon model obtained by mathematization of metallurgical phenomena on online setting computer automatically learns the model as needed using actual mechanical properties values obtained from mechanical properties measurement test results such as tensile tests conducted on part of product coils. (for example, the method in Patent Literature 4, etc.) However, the actual measured values of mechanical properties are measured on a test piece cut out from part of the coil, such as the head end or tail end of the coil. Therefore, it is generally impossible to obtain actual measured values of changes in mechanical properties due to differences in operating conditions such as the above-mentioned temperature in the rolling direction and the temperature in the bar or strip width direction, and the changes are not reflected in the learning of the metallurgical phenomenon model. In the operating conditions obtained from these actual measured values of mechanical properties, the mechanical properties prediction results of the metallurgical phenomenon model including learning become exceptional values, so that changes in mechanical properties prediction results are not smooth for changes in operating conditions. The material properties calculation unit 45 uses a metallurgical phenomenon model that does not include learning, rather than a metallurgical phenomenon model that is automatically learned in actual operation.

The objective variable setting unit 46 extracts data corresponding to the objective variables 20 from the mechanical properties created by the material properties calculation unit 45. The objective variable setting unit 46 then adds the extracted data to the dataset 36 as the objective variables 20, each of which becomes a pair with the explanatory variable 37 created from the operating conditions used by the material calculation unit 12.

The model parameter determination unit 29 uses the dataset 36 created by the dataset creation unit 28, to determine model parameters configuring the approximate model 39 that simply simulates the mechanical properties prediction calculation performed by the material calculation unit 12 through metallographic structure prediction, which requires a large load.

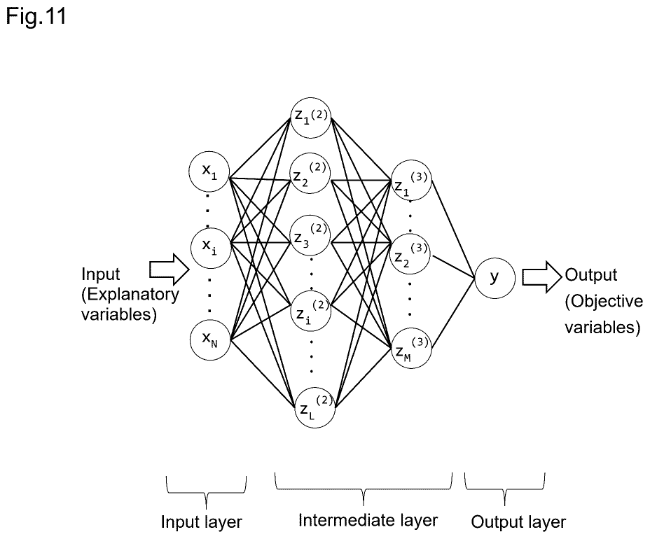

FIG. 11 is a schematic diagram showing an example of an approximate model. As an approximate model 39, a machine learning model can be used. In the example shown in FIG. 11, a machine learning model is built by a forward propagation neural network configured with an input layer, an intermediate layer, and an output layer. Explanatory variables 37, which are operating conditions, are input to the input layer. The output layer outputs objective variables 20 that are mechanical properties.

In the example of building an approximate model with a forward propagation neural network, the model parameter determination unit 29 determines hyperparameters and parameters of the forward propagation neural network. The hyperparameters include network configuration (number of intermediate layers, number of units) and types of activation functions. The hyperparameters are determined empirically or through trial and error. Alternatively, the hyperparameters are determined by techniques that has been recently used commonly, such as grid search and Bayesian optimization. The parameters are weighting coefficients and biases of each unit expressing the functions of the forward propagation neural network. A function itself is unknown that accurately predicts mechanical properties under all operating conditions. However, if a function is given a large number of input/output pairs, adjustment of the parameters makes it possible to create the function that well reproduces these input/output pairs. The input/output pairs are called training data. The parameters are selected so that an output of the neural network when training data input (an explanatory variable) is given to the function is as close as possible to the training data output (an objective variable). The explanatory variables 37 of the dataset 36 created by the dataset creation unit 28 are used for inputs, the objective variable 20 of the dataset 36 are used for outputs, and the pairs of explanatory variables 37 and objective variables 20 are used to adjust the parameters. For learning, part of the pairs in the dataset, for example, about 70% of the total, are used as training data. An error function expressed as a squared error or the like is used as a measure of the reproducibility of a function expressed by a neural network. A neural network is learned by solving minimization problems of error functions. In forward propagation neural network learning, gradient descent, Adam that is an improved method thereof, and the like are known as an optimization method for solving the error function minimization problems mentioned above. For example, the model parameter determination unit 29 uses Adam to learn a forward propagation neural network. After confirmation of the model generalization performance with the holdout method and cross-validation, if necessary, the parameters may be readjusted again by taking measures that are commonly used in building machine learning models, such as changing hyperparameters, increasing the number of data pairs in the dataset, and reviewing data preprocessing. Furthermore, if new pairs of explanatory variables 37 and objective variables 20 are added to the dataset from time to time after building a machine learning model with the above procedure, learning may be performed successively using gradient descent, or the like. This is the case in which online rolling data is obtained from time to time, in which offline setting calculation is executed from time to time, or the like. Alternatively, in regular maintenance, the dataset may be recreated with the latest data, and an approximate model may be rebuilt and replace the old model. The types of explanatory variables also can be changed depending on types of mechanical properties to be predicted. It is preferable to create different approximate models for each mechanical properties.

The material properties prediction unit 27 uses an approximate model 39 created in advance offline by the approximate model creation unit 26, to online predict the mechanical properties of individual three-dimensional mesh-shaped areas of the product coil to be actually manufactured on the rolling line 1.

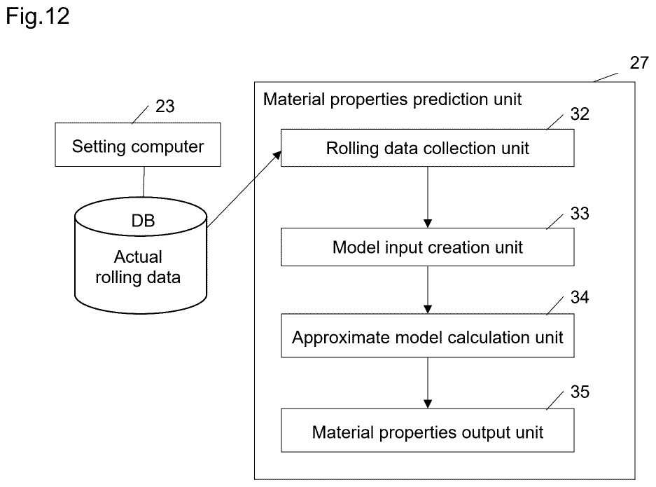

FIG. 12 is a block diagram showing a configuration of the material properties prediction unit 27. As shown in FIG. 12, the material properties prediction unit 27 includes a rolling data collection unit 32, a model input creation unit 33, an approximate model calculation unit 34, and a material properties output unit 35. The rolling data collection unit 32 collects rolling data at each part of the coil from the heating furnace to coiling. The model input creation unit 33 creates input data to the approximate model 39 from the rolling data collected by the rolling data collection unit 32. The approximate model calculation unit 34 calculates the mechanical properties of each three-dimensional mesh-shaped area of the product coil with the input data created by the model input creation unit 33 and the approximate model 39. The material properties output unit 35 outputs the mechanical properties calculated by the approximate model calculation unit 34 together with information representing the position in the product.

The rolling data collection unit 13 collects rolling data such as the chemical component, processing histories, and temperature histories of the product coil calculated by the setting computer 23. The rolling data is predicted values before rolling, predicted values and values recalculated with actual values during rolling, and values recalculated with actual values after rolling, and the information accuracy differs depending on the obtaining timing. When mechanical properties are predicted for the purpose of product quality control, the data is preferably collected at the timing when the values recalculated with actual values are completed after winding is completed by the down coiler 19.

The model input creation unit 33 extracts data corresponding to the explanatory variables 37 of each three-dimensional mesh-shaped area of the product coil, from the rolling data of the product coil collected by the rolling data collection unit 13, as input data to the approximate model 39. If the rolling data collected by the rolling data collection unit 13 is insufficient to create the explanatory variables 37 for each three-dimensional mesh-shaped area, the explanatory variables 37 are created by supplementing the missing data. For example, there has recently been cases in which temperature distributions in the thickness direction and the width direction of the material-to-be-rolled are calculated with actual temperatures measured by the pyrometers and model predictions. However, due to the computational load, the setting computer 23 may intentionally limit the calculation range in such a way that it calculates the temperature distribution in the width direction up to the edge heater delivery side, which is necessary for control, and stops calculation downstream relative to the edge heater. In such a case, the rolling data collection unit 13 uses: the actual value of the temperature distribution in the width direction measured with the multi gauge downstream, for example, on the finishing mill delivery side; the temperature distribution in the width direction on the edge heater delivery side calculated by the model, or actual temperature distribution in the width direction of the scan pyrometer on the edge heater delivery side; and the temperature history calculation results at the central part in the width direction from the edge heater delivery side to the finishing mill delivery side, to create data of explanatory variables 37 regarding the temperatures of each mesh in the width direction, for example, finishing mill entry-side temperatures, by using an interpolation formula such as linear interpolation. Alternatively, the temperature distribution in the width direction may be calculated using an offline setting computer. Further, part of the processing histories such as the strain rates in rolling in the thickness direction is commonly not performed in the bar or strip width direction. This is because, in rolling in the bar or strip thickness direction, the contact length between the roll and the deformation zone of the material is quite short compared to the width of the material, so there is little movement of the material in the width direction and the thickness reduction becomes mainly elongation in the rolling direction. In this case, the data calculated at the central part in the width direction can be duplicated in the bar or strip width direction to be used as the explanatory variables 37. Furthermore, for data such as chemical components for which only one value can be obtained for a product coil, the same value is used for all meshes.

The approximate model calculation unit 34 inputs the input data created by the model input creation unit 33 into the approximate model 39 created in advance by the approximate model creation unit 26, and calculates the mechanical properties of each three-dimensional mesh-shaped area of the product coil.

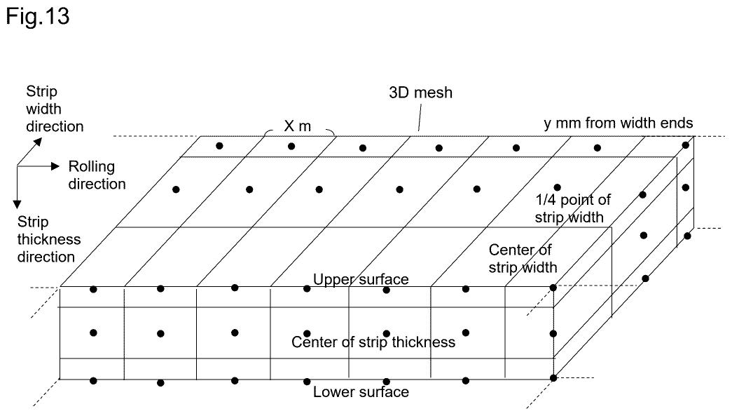

FIG. 13 is a schematic diagram of an example showing a mesh area for which the approximate model calculation unit 34 calculates material properties. Although FIG. 13 shows part of the total length and one half in the strip width direction (work side or drive side) for simplicity, the approximate model calculation unit 34 performs calculation for the entire length and the entire width. Although the calculation interval set in the rolling direction may vary depending on the product strip thickness, for example, rolling data is created at 2 m intervals, and mechanical properties are also predicted at similar intervals. In the strip thickness direction, for example, the mechanical properties at three points are predicted: the upper surface, the center of the strip thickness, and the lower surface. In the width direction, for example, mechanical properties are predicted for a total of five points: points 40 mm from the width ends (each on the work side and the drive side); midpoints between each width end and the center of the strip width (¼ point of the strip width) (each on the work side and the drive side); and the center point in the strip width.

The material properties output unit 35 outputs the mechanical properties of each area calculated by the approximate model calculation unit 34, information expressing the position of each area in the rolled product, and information highly related to variations in mechanical properties. The positions of each area in the above-mentioned rolled product are the distance from the head end in the rolling direction, the distance from the tail end, the position in the width direction, and the position in the thickness direction. The above-mentioned information related to mechanical properties is information that is highly related to variations in mechanical properties and includes, for example, finishing mill delivery-side temperature, coiling temperature, and cooling rate. The output destination is a storage device such as a database and a visualization device such as an HMI. In outputting to a visualization device, the output data is visualized in a graph or numerical values are shown in a table or the like. These are used as reference values in considering whether to conduct a tensile test, product grade determination, cutting length at the dividing line, and process parameters for rolled products in the same lot. Information representing the mechanical properties of each area, the position in the rolled product, and information closely related to variations in mechanical properties can be obtained at high speed, so that they can be reflected in the above process parameters for the next material or the same lot material.

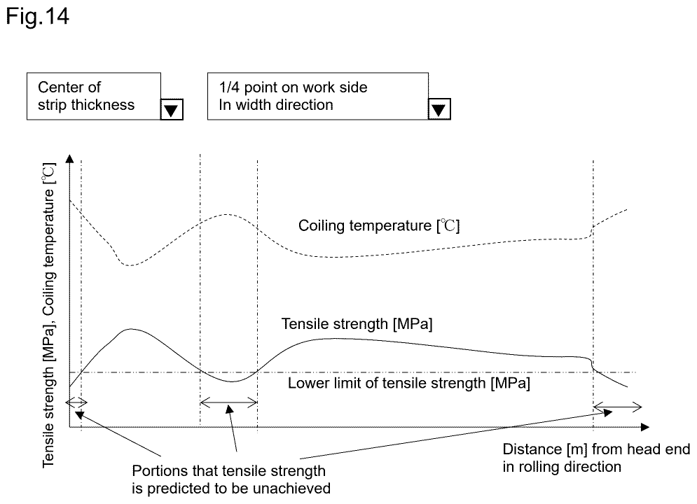

FIG. 14 is a schematic diagram showing an example of the output of the material properties output unit 35. The horizontal axis shows the position in the rolling direction (distance from the head end), and the vertical axis shows changes in tensile strength and coiling temperature. Further, any positions can be selected in the strip thickness direction and the width direction, and in this example, the center of the strip thickness and the ¼ point on the work side in the width direction are selected. When the lower limit of tensile strength is given, information can be obtained that includes the positions of the material-to-be-rolled where the tensile strength is below the lower limit and the relationship with the coiling temperatures. Changing the horizontal axis to the strip thickness direction or strip width direction allows the mechanical properties distribution to be visualized in each direction. As another output method, the distribution of mechanical properties of the entire product may be visualized with a three-dimensional mesh-shaped heat map. Information to be visualized in the table includes, for example, information about positions (distance from the head end and tail end) where the mechanical properties are unachieved, basic statistics such as the average value and standard deviation of mechanical properties, and correlation coefficient between mechanical properties and explanatory variables 37.

As described above, according to the present embodiment, datasets are also comprehensively created in advance that corresponds to rolling conditions (temperature conditions, processing conditions, and time/speed conditions) that have not been implemented in actual rolling processes, or rolling conditions that have little experience therein. In this way, an approximate model is created offline using a dataset created to cover all rolling conditions, including rolling conditions that have not been implemented or have little experience, and thereby an approximate model can be created that is applicable to the entire group of rolled products and has high approximation accuracy. Use of the approximate model created in this way allows reduction of the calculation load for online prediction of material properties in each three-dimensional mesh-shaped area of any rolled product. Moreover, the use allows calculating and monitoring the material properties of all areas (parts) of the rolled product. This allows the results of the rolled product to be reflected in operational changes in the next rolled product or rolled products in the same lot.

### Embodiment 2

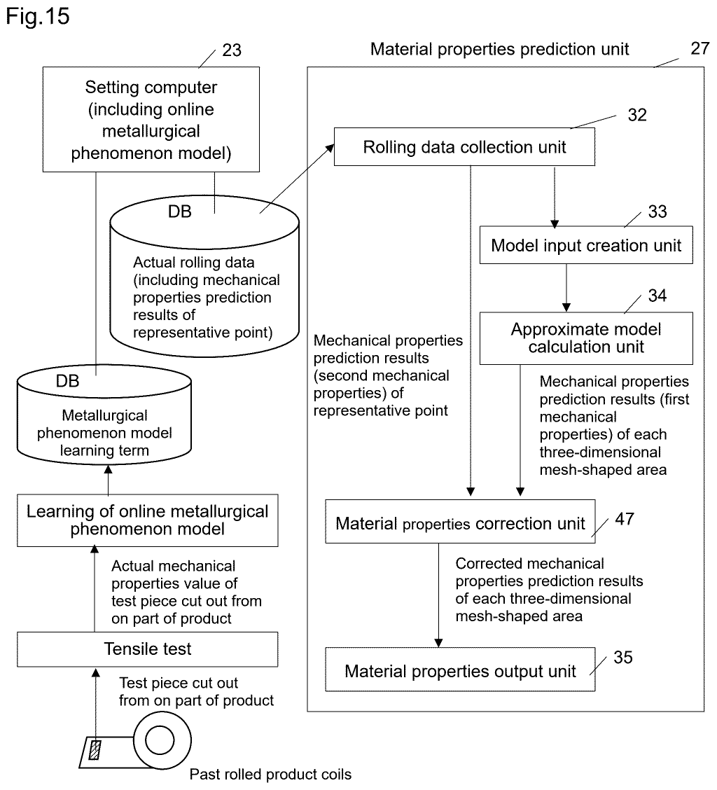

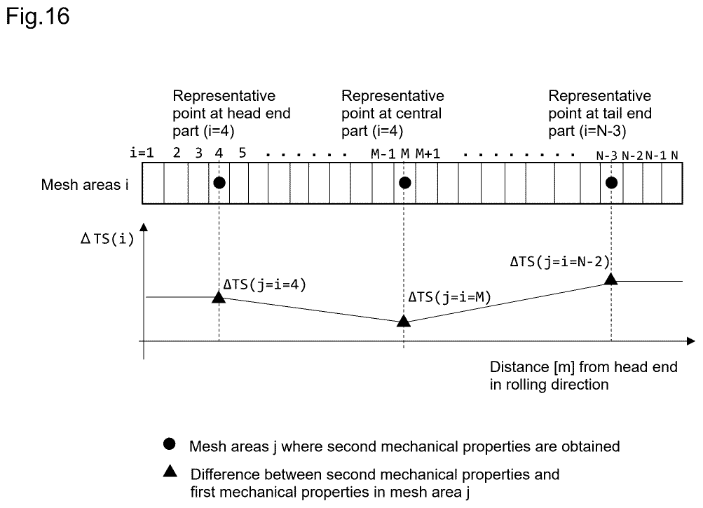

Next, Embodiment 2 of the present invention will be described with reference to FIGS. 15 and 16, focusing on the differences from Embodiment 1 described above, and identical or equivalent parts will be denoted by the same reference numerals and characters and the explanation will be omitted.

FIG. 15 is a block diagram showing a configuration of the material properties prediction unit 27 according to Embodiment 2. The mechanical properties prediction unit 27 as a material properties prediction unit includes a material properties correction unit 47 that corrects mechanical properties, which is calculated by the approximate model calculation unit 34 using the approximate model 39 (hereinafter referred to as a “first mechanical properties”), using mechanical properties, which is calculated by a metallurgical phenomenon model obtained by mathematization of metallurgical phenomena (hereinafter referred to as a “second mechanical properties”). The metallurgical phenomenon model, which is obtained by mathematization of the metallurgical phenomena that predicts the second mechanical properties, performs model learning using actual mechanical properties values obtained in past tensile tests of rolled products (product coils). The second mechanical properties are collected from the online setting computer 23 by the rolling data collection unit 13 as part of the rolling data.

In parts of the rolled product, for example, a representative point at the head end part, a representative point at the central part, and a representative point at the tail end part in the rolling direction, the mechanical properties of the center in the width direction of each part may be calculated by the online setting computer or a computer connected to the online setting computer using the metallurgical phenomenon model obtained by mathematization of metallurgical phenomena. Furthermore, the metallurgical phenomenon model, which is obtained by mathematization of metallurgical phenomena, performs model learning using actual mechanical properties values obtained from mechanical properties measurement test results such as tensile tests and structure observations conducted on part of product coils, or is adjusted to match the actual mechanical properties (for example, the method of Patent Literature 4). The prediction accuracy of the second mechanical properties predicted through learning and adjustment in this way can be expected to be sufficient.

There will be shown an example of a method for correcting the first mechanical properties with the material properties correction unit 47. It is assumed that the second mechanical properties are obtained in an area j among the mesh areas for which the approximate model calculation unit 34 calculates the first mechanical properties. In the following, a case in which the mechanical properties are tensile strength will be explained as an example.

First, the difference between the second mechanical properties and the first mechanical properties in the mesh area j where the second mechanical properties have been obtained is determined with the following expression (5).

$$Δ TS ( j ) = {TS}_{MM} ( j ) - {TS}_{ML} ( j ) \qquad ( 5 )$$

Here, j is an index indicating the mesh area where the second mechanical properties has been obtained, TS_{MM}(j) is the second mechanical properties included in the actual rolling data, TS_{ML}(j) is the first mechanical properties calculated by the approximate model calculation unit 34, and ΔTS(j) is the difference between the second mechanical properties and the first mechanical properties.

FIG. 15 is a schematic diagram showing a correction method in the material properties correction unit 47 in Embodiment 2 of the present invention. For example, if the second mechanical properties at the center in the width direction of the representative point at the head end part, representative point at the central part, and representative point at the tail end part in the rolling direction are obtained, the differences ΔTS(i) between the second mechanical properties and the first mechanical properties each assumed in other mesh areas i are calculated by linear interpolation or the like using ΔTS(j) at the above three points.

Next, using the difference ΔTS(i) between the second mechanical properties and the first mechanical properties, the mesh area i is corrected using the following expression (6).

$${TS}_{comp} ( i ) = {TS}_{ML} ( i ) + α \cdot Δ TS ( i ) \qquad ( 6 )$$

Here, i is an index indicating the mesh area, tensile strength of which is to be corrected, TS_{ML}(i) is the tensile strength calculated by the approximate model calculation unit 34 with the approximate model 39, α is a correction adjustment coefficient (=0 to 1), and TS_{comp}(i) is the corrected tensile strength.

As explained above, according to the present embodiment, the material properties correction unit 47 is provided, and this allows for improving the prediction accuracy of the mechanical properties of all parts of the rolled product. Moreover, this does not affect online calculations for actual rolling operation. Note that although an example of predicting mechanical properties of material properties has been described above, the same applies to electromagnetic properties.

Although the embodiments of the present invention have been described above, the present invention is not limited to the above embodiments, and can be implemented with various modifications without departing from the spirit of the present invention. In the embodiments described above, when the number, quantity, amount, range, etc. of each element is mentioned, unless clearly expressed or clearly specified to the number in principle, the invention is not limited to the mentioned numbers. Furthermore, the structures described in the above-described embodiments are not necessarily essential to the present invention, unless clearly expressed or clearly specified to it in principle.

In the above embodiment, the case in which mechanical properties are predicted as material properties is explained as an example, but the same applies to the case in which electromagnetic properties are predicted.

### REFERENCE SIGNS LIST

1 . . . rolling line, 25 . . . material properties prediction device for rolled products, 26 . . . approximate model creation unit, 27 . . . material properties prediction unit, 28 . . . dataset creation unit, 29 . . . model parameter determination unit, 30 . . . condition setting unit, 31 . . . material calculation unit, 36 . . . data set, 37 . . . explanatory variables, 38 . . . objective variables, 47 . . . material properties correction unit

1. A material properties prediction device for rolled products, the material properties prediction device predicting material properties of a rolled product manufactured on a rolling line, the material properties prediction device comprising:
approximate model creation circuitry that offline creates an approximate model that comprehensively predicts not only material properties of a group of rolled products actually to be manufactured on the rolling line, but also material properties of a group of virtual rolled products that has not actually manufactured on the rolling line but may be manufactured in the future; and
material properties prediction circuitry that online predicts material properties in individual three-dimensional mesh-shaped areas of a rolled product manufactured on the rolling line, by using the approximate model created by the approximate model creation circuitry,
wherein the approximate model creation circuitry includes:
dataset creation circuitry has condition setting circuitry that sets rolling conditions for the group of rolled products, and material calculation circuitry that calculates metallurgical phenomena and material properties under the rolling conditions, the dataset creation circuitry creating a dataset to be used to create the approximate model; and
model parameter determination circuitry that determines parameters expressing the approximate model using the dataset, and
wherein the dataset creation circuitry creates the dataset in which the rolling conditions extracted from rolling data of the group of rolled products actually manufactured on the rolling line and virtual rolling conditions extracted from virtual rolling data of the group of virtual rolled products virtually rolled are used as explanatory variables and in which the material properties calculated by the material calculation circuitry are used as objective variables.

2. (canceled)

3. The material properties prediction device for rolled products according to claim 1, wherein the material properties prediction circuitry includes:
rolling data collection circuitry that online collects rolling data obtained in manufacturing rolled products on the rolling line;
model input creation circuitry that online creates input data to the approximate model, from the rolling data collected by the rolling data collection circuitry;
approximate model calculation circuitry that online calculates material properties of individual three-dimensional mesh-shaped areas of a product coil by inputting the input data created by the model input creation circuitry into the approximate model; and
material properties output circuitry that outputs material properties of the individual areas calculated by the approximate model calculation circuitry, information expressing positions of the individual areas in the rolled product, and information related to the material properties.

4. The material properties prediction device for rolled products according to claim 1, wherein the approximate model is a machine learning model.

5. The material properties prediction device for rolled products according to claim 1, wherein the material properties prediction circuitry includes material properties correction circuitry that corrects material properties using material properties results, the material properties being calculated by the approximate model calculation circuitry using the approximate model, the material properties results being calculated using a metallurgical phenomenon model obtained by mathematization of metallurgical phenomena.
